(19) United States
(12) Patent Application Publication
(10) Pub. No.: US 2017/0147089 A1
(43) Pub. Date: May 25, 2017

(54) METHOD AND DEVICE FOR OPTIMIZING AIR MOUSE REMOTE CONTROLLER AND TERMINAL DEVICE

(71) Applicant: Xiaomi Inc., Beijing (CN)

(72) Inventors: Xin LIANG, Beijing (CN); Kangxi Tan, Beijing (CN)

(73) Assignee: Xiaomi Inc.

(21) Appl. No.: 15/188,146

(22) Filed: Jun. 21, 2016

(30) Foreign Application Priority Data
Nov. 20, 2015 (CN) 201510809888.8

(51) Int. Cl. G06F 3/038; G06F 3/0346

(52) U.S. Cl. CPC G06F 3/038; G06F 3/0346

(57) ABSTRACT

The present disclosure relates to a method and a device for optimizing an air mouse remote controller. The optimization method includes: obtaining operation instructions from an air mouse remote controller at a first time point; determining a first control selected by the air mouse remote controller on an operation interface of a terminal device at a second time point, the second time point being earlier than the first time point, and a time difference between the first time point and the second time point being a preset length of time; and performing an operation corresponding to the first control.

### CROSS-REFERENCE TO RELATED APPLICATIONS

This application is based upon and claims priority to Chinese Patent Application No. 201510809888.8, filed Nov. 20, 2015, the entire contents of which are incorporated herein by reference.

### TECHNICAL FIELD

The present disclosure relates to computer technologies and, more particularly, to a method and a device for optimizing an air mouse remote controller and a terminal device.

### BACKGROUND

With technology advances in the smart home industry, applications of air mouse remote controllers have become more and more popular, gradually replacing traditional remote controllers to control terminal devices, such as a smart television. An air mouse remote controller generally uses a motion sensor to identify motion trajectories of the air mouse controller, and simulate mapping operations between the air mouse controller and a cursor on a screen of a terminal device. That is, an operation interface on the screen can be controlled by moving the air mouse remote controller, and a user can select a corresponding operation through the cursor by pressing a key of the air mouse remote controller. However, since the user's hand may move when pressing the key, the position selected by the cursor mapped on the screen may displace from where the user desires, causing a mis-click and poor user experience.

### SUMMARY

According to a first aspect of the present disclosure, there is provided a method for optimizing an air mouse remote controller, comprising: obtaining operation instructions from an air mouse remote controller at a first time point; determining a first control selected by the air mouse remote controller on an operation interface of a terminal device at a second time point, the second time point being earlier than the first time point, and a time difference between the first time point and the second time point being a preset length of time; and performing an operation corresponding to the first control.

According to a second aspect of the present disclosure, there is provided a terminal device, comprising: a receiver configured to obtain operation instructions from an air mouse remote controller at a first time point; and a processor configured to: determine a first control selected by the air mouse remote controller on an operation interface of the terminal device at a second time point, the second time point being earlier than the first time point, and a time difference between the first time point and the second time point being a preset length of time; and perform an operation corresponding to the first control.

According to a third aspect of the present disclosure, there is provided a non-transitory computer-readable storage medium comprising instructions that, when executed by a processor in a device for optimizing an air mouse remote controller, cause the device to perform a method comprising: obtaining operation instructions from the air mouse remote controller at a first time point; determining a first control selected by the air mouse remote controller on an operation interface of the device at a second time point, the second time point being earlier than the first time point, and a time difference between the first time point and the second time point being a preset length of time; and performing an operation corresponding to the first control.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention, and together with the description, serve to explain the principles of the invention.

FIG. 1 is a flow chart illustrating a method for optimizing an air mouse remote controller, according to an exemplary embodiment.

FIG. 2 is a flow chart illustrating another method for optimizing an air mouse remote controller, according to an exemplary embodiment.

FIG. 3 is a flow chart illustrating another method for optimizing an air mouse remote controller, according to an exemplary embodiment.

FIG. 4 is a block diagram illustrating a device for optimizing an air mouse remote controller, according to an exemplary embodiment.

FIG. 5 is a block diagram illustrating another device for optimizing an air mouse remote controller, according to an exemplary embodiment.

FIG. 6 is a block diagram illustrating another device for optimizing an air mouse remote controller, according to an exemplary embodiment.

FIG. 7 is a block diagram illustrating another device for optimizing an air mouse remote controller, according to an exemplary embodiment.

FIG. 8 is a block diagram illustrating another device for optimizing an air mouse remote controller, according to an exemplary embodiment.

FIG. 9 is a block diagram illustrating a terminal device for optimizing an air mouse remote controller, according to an exemplary embodiment.

FIG. 10 is a block diagram illustrating another terminal device for optimizing an air mouse remote controller, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

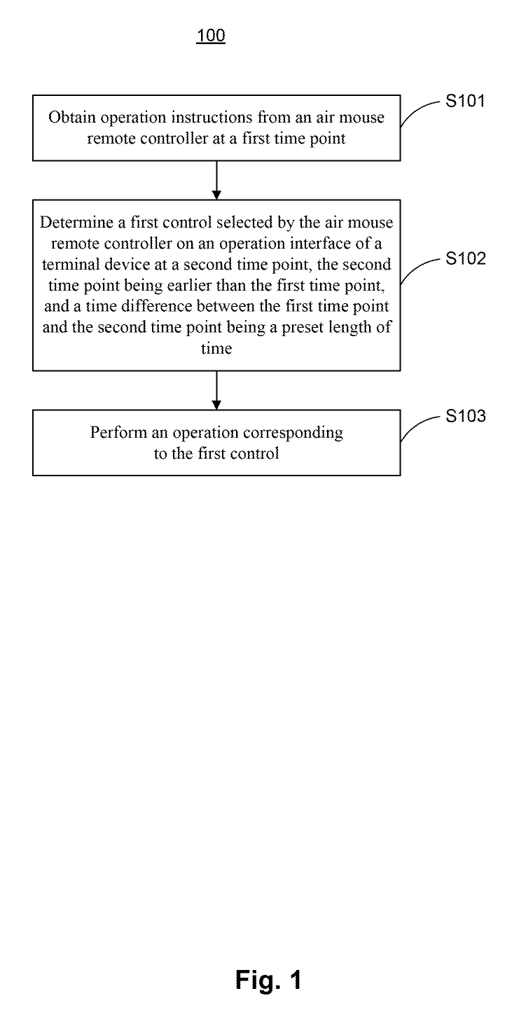

FIG. 1 is a flow chart illustrating a method 100 for optimizing an air mouse remote controller, according to an exemplary embodiment. As shown in FIG. 1, the method 100 can be implemented by a terminal device. The terminal device may be a television, a personal computer, a remote-controlled projector, and the like. By using the method 100, accuracy of the operation of the air mouse remote controller can be improved. The method 100 may include the following steps.

In step S101, operation instructions from an air mouse remote controller at a first time point are obtained.

In some embodiments, the terminal device (such as a smart television), which can be controlled and operated by the air mouse remote controller, may obtain operation instructions sent by the air mouse remote controller, and a time point when the operation instructions is received. The operation instructions may carry a time point of sending the operation instructions. The time point can also be acquired over a network when the terminal device receives the operation instructions.

In step S102, a first control selected by the air mouse remote controller on an operation interface of the terminal device at a second time point is determined, the second time point being earlier than the first time point, and a time difference between the first time point and the second time point being a preset length of time. Step S102 may be performed before or after S101.

In some embodiments, the second time point may refer to a time point before the first time point, and a length of time between the first time point and the second time point may be the preset length of time, which can be obtained using a statistical method from experiments. For example, the statistical method may include statistically calculating a length of time from a user begins to press the key to the user stops pressing the key, and correspondingly acquiring an average value or a preferred value to use as the preset length of time.

When the key of the air mouse remote controller is pressed, since the user's hand is hanging in the air, there may be an instantaneous displacement of the hand during the operation, and the motion sensor in the air mouse remote controller may detect the displacement, causing a position of the cursor on the terminal device to move correspondingly and away from the originally selected control. The problem may be solved by compensating a time for pressing the key, e.g., determining a first control selected by the cursor at the second time point before the first time point as an operation control that the user wants to select.

In step S103, an operation corresponding to the first control is performed.

In some embodiments of the present disclosure, when the operation instructions sent by the user through the air mouse remote controller at the first time point are received, no operation may be performed on the control on the interface of the terminal device selected at the first time point. Instead, the first control selected at the second time point is to be performed. Thus, the displacement during a press operation of the user can be compensated, the selection error due to the hand displacement during the key operation can be avoided, and the accuracy of the terminal device controlled by the air mouse remote controller can be improved effectively.

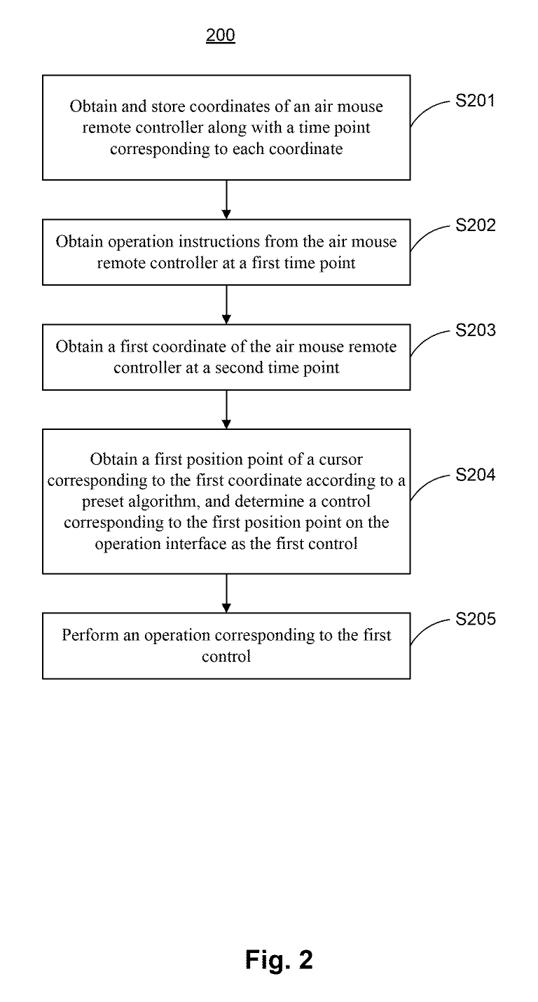

FIG. 2 is a flow chart illustrating a method 200 for optimizing an air mouse remote controller, according to an exemplary embodiment. The method 200 may include the following steps.

In step S201, coordinates of an air mouse remote controller along with a time point corresponding to each coordinate sent by the air mouse remote controller are obtained and stored in real time.

In some embodiments, the motion sensor or other devices capable of detecting the position in the air mouse remote controller may acquire coordinates of the air mouse at different times and time points of coordinate acquisitions according to the movement of the air mouse remote controller, and send the coordinates and the time points to the terminal device. After receiving the real-time coordinates and the time points, the terminal device may store these data in a storage medium.

In some embodiments, in order to save the storage space of the terminal device, the terminal device may be configured to store data, e.g. the coordinates and the time points, within a period of time, for example, data within one minute. Data received and stored earlier than one minute can be deleted, as long as the stored data can be used to obtain the coordinates of the air mouse remote controller and the time points before the preset length of time.

In addition, a time point corresponding to each coordinate of the air mouse remote controller can be sent by the air mouse remote controller, or can be acquired by the terminal device.

In step S202, operation instructions from the air mouse remote controller at a first time point are obtained.

In step S203, a first coordinate of the air mouse remote controller at a second time point is obtained.

In some embodiments, the terminal device may obtain the operation instructions and the coordinate of the air mouse remote controller at the second time point before the first time point. The coordinate can be a space coordinate obtained by a motion sensor.

In step S204, a first position point of a cursor corresponding to the first coordinate is obtained according to a preset algorithm, and a control corresponding to the first position point on the operation interface is determined as the first control.

In some embodiments, a mapping relationship between the air mouse remote controller and the operation interface of the terminal device may be established through the preset algorithm, for example, displacement algorithm, attitude algorithm, six-axis attitude fusion algorithm accounting for three-axis gyroscope and three-axis accelerator measurement, and the like, as long as the position of the corresponding cursor on the operation interface of the terminal device can be obtained from the coordinate of the air mouse remote controller. The terminal device may determine the control corresponding to the position point selected by the cursor at the second time point.

In step S205, an operation corresponding to the first control is performed.

In some embodiments of the present disclosure, the operation corresponding to the first control can be performed after the time error is compensated.

In some embodiments of the present disclosure, erroneous displacement during a press operation by a user can be compensated by time adjustment. A terminal device may record and store coordinate information of the position points on the motion trajectories of the air mouse remote controller within a period of time and a time point corresponding to each position point, calculate a second time point from the first time point and the preset length of time after receiving the operation instructions, search and acquire coordinates of the air mouse remote controller at the second time point from the stored information, acquire a control selected by the air mouse remote controller at this position according to the preset algorithm and a mapping relationship, and perform an operation corresponding to the control. Thus, the displacement during a press operation of the user can be compensated, the selection error due to the hand displacement during the key operation can be avoided, and the accuracy of the terminal device controlled by the air mouse remote controller can be improved effectively.

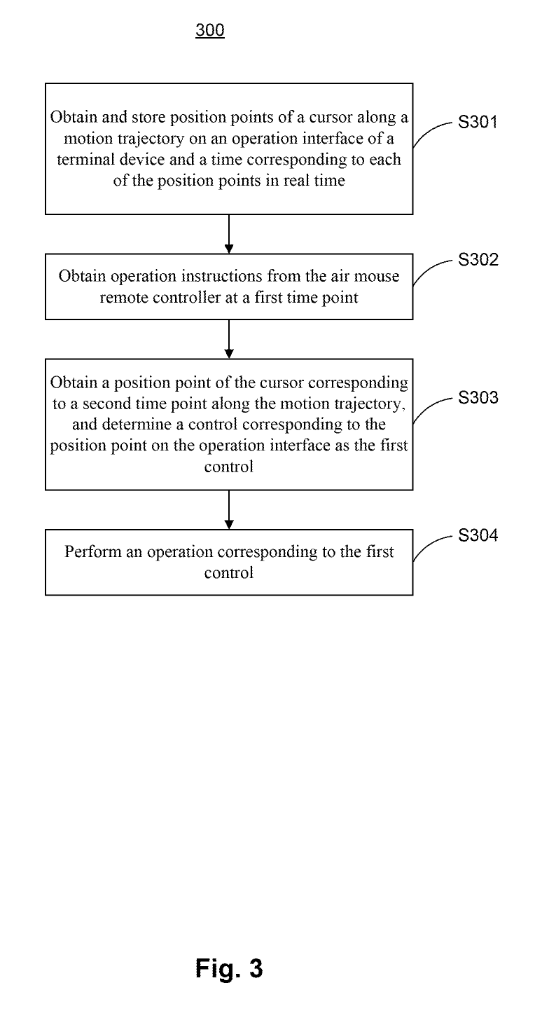

FIG. 3 is a flow chart illustrating a method 300 for optimizing an air mouse remote controller, according to an exemplary embodiment. The method 300 may achieve compensation of the displacement of a user hand through a coordinate and a time point of a cursor and may include the following steps.

In step S301, position points of a cursor along a motion trajectory on an operation interface of a terminal device and a time corresponding to each of the position points are obtained and stored in real time. The cursor corresponds to an air mouse remote controller.

In the some embodiments, the terminal device may not need to store coordinate information of the air mouse remote controller, but may acquire a trajectory of a cursor on an operation interface, positions points of the cursor along the trajectory and corresponding to the air mouse remote controller, and time points when the cursor moves to the position points, according to a preset algorithm. The time points may be sent by the air mouse remote controller, or acquired by the terminal device.

In some embodiments, in order to save the storage space of the terminal device, the terminal device may be configured to store data, e.g. the coordinates and the time points, within a period of time, for example, data within one minute. Data received or stored earlier than one minute can be deleted.

In step S302, operation instructions from the air mouse remote controller at a first time point are obtained.

In step S303, a position point of the cursor corresponding to a second time point along the motion trajectory is obtained, and a control corresponding to the second position point on the operation interface is determined as the first control.

In the some embodiments, after obtaining the operation instructions, movement of the cursor may be traced backed to the position point corresponding to the second time point based on the motion trajectory of the cursor (the second time point may be earlier than the first time point). Accordingly, the control selected at the second position point may be determined as a control that the user wants to select.

In step 304, an operation corresponding to the first control is performed.

For example, recent data (such as position points and/or time points within 10 ms) before a present time point can be recorded and stored in a cache. After a key operation is detected, position of the air mouse remote controller can be traced back for a period of time (such as 10 ms) to compensate for hand displacement during pressing the key. Thus, the accuracy of pressing the key of the air mouse can be optimized. The above preset length of time may be set according to actual needs.

In some embodiments of the present disclosure, erroneous displacement during a press operation by a user can be compensated by time adjustment. A terminal device may record and store coordinate information of the position points on the motion trajectories of the air mouse remote controller within a period of time and a time point corresponding to each position point, calculate a second time point from the first time point and the preset length of time after receiving the operation instructions, search and acquire coordinates of the air mouse remote controller at the second time point from the stored information, acquire a control selected by the air mouse remote controller at this position according to the preset algorithm and a mapping relationship, and perform an operation corresponding to the control. Thus, the displacement during a press operation of the user can be compensated, the selection error due to the hand displacement during the key operation can be avoided, and the accuracy of the terminal device controlled by the air mouse remote controller can be improved effectively.

If, after the compensation, the air mouse remote controller does not select any control, the position of the cursor on the operation interface of the terminal device can be detected, and a control closest to the position can be acquired based on the position of the cursor and the position of the control. Alternatively, a control within a certain distance range of the position can be determined as the first control. These methods may also be used to improve the accuracy on mouse operation.

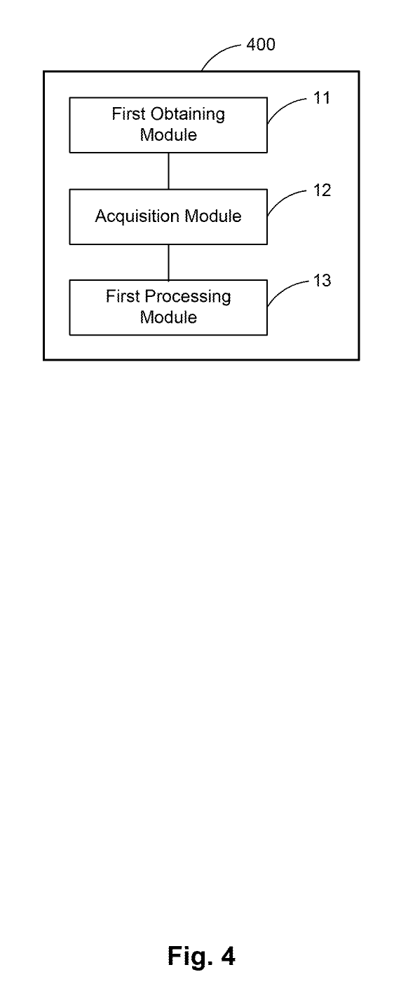

FIG. 4 is a block diagram illustrating a device 400 for optimizing an air mouse remote controller, according to an exemplary embodiment. Referring to FIG. 4, the device 400 may include: a first obtaining module 11 configured to obtain operation instructions from an air mouse remote controller at a first time point; an acquisition module 12 configured to determine a first control selected by the air mouse remote controller on an operation interface of a terminal device at a second time point, the second time point being earlier than the first time point, and a time difference between the first time point and the second time point being a preset length of time; and a first processing module 13 configured to perform an operation corresponding to the first control.

In some embodiments of the present disclosure, when the first obtaining module 11 obtains the operation instructions sent by the user via the air mouse remote controller at the first time point, the second time point before the preset length of time may be obtained through the acquisition module 12. The first processing module 13 may use a control selected at the second time point as the first control, and perform the operation corresponding to the first control. That is, displacement during a press operation of the user can be compensated. Thus, selection error due to that the user's hand movement during the key operation can be accounted for, and the accuracy of the terminal device controlled by the air mouse remote controller can be improved.

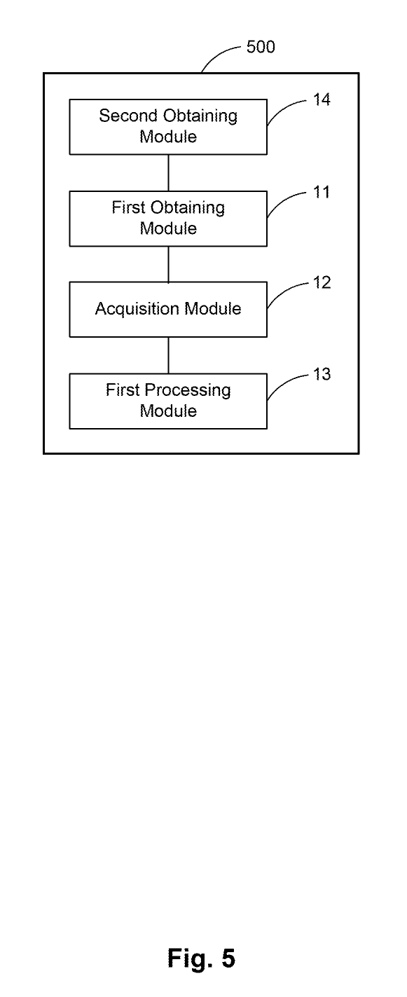

FIG. 5 is a block diagram illustrating a device 500 for optimizing an air mouse remote controller, according to an exemplary embodiment. In addition to the first obtaining module 11, the acquisition module 12, and the first processing module 13 (FIG. 4), the device 500 may further include: a second obtaining module 14 configured to obtain and store coordinates of an air mouse remote controller along with a time point corresponding to each of the coordinates in real time.

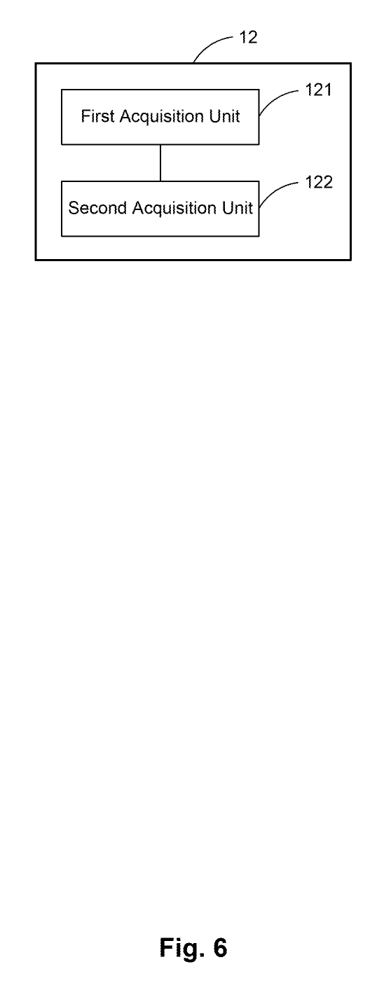

FIG. 6 is a block diagram illustrating the acquisition module 12 (FIG. 4), according to an exemplary embodiment. Referring to FIG. 6, the acquisition module 12 may include: a first acquisition unit 121 configured to acquire a first coordinate of the air mouse remote controller at a second time point; and a second acquisition unit 122 configured to acquire a first position point of a cursor corresponding to the first coordinate according to a preset algorithm, and determine a control corresponding to the first position point on the operation interface as the first control.

The device for optimizing the air mouse remote controller may record and store coordinate information of position points along the motion trajectory of the air mouse remote controller within a period of time and a time point corresponding to each position point, calculate a second time point through the first time point and the preset length of time after receiving the operation instructions, search and acquire coordinates of the air mouse remote controller at the second time point from the stored information, acquire a control selected by the air mouse remote controller at this position according to the preset algorithm and a mapping relationship, and perform an operation corresponding to the control. Thus, selection error due to that the user's hand movement can be avoided, and the accuracy of the operation of the air mouse remote controller can be improved.

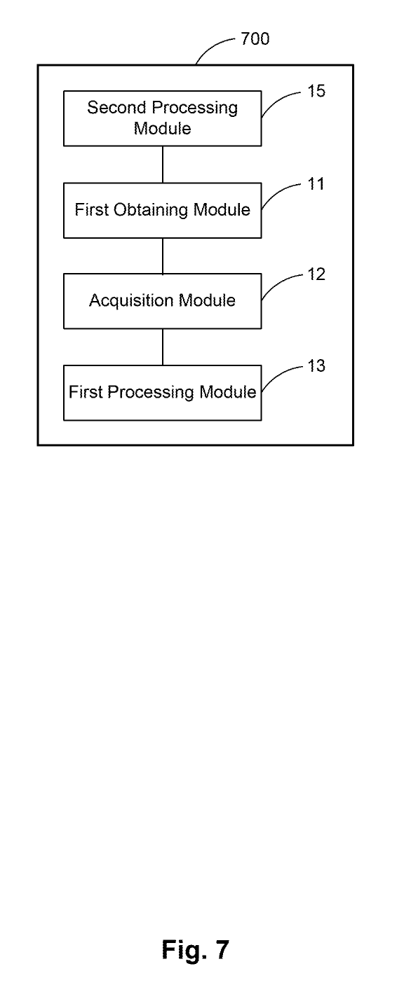

FIG. 7 is a block diagram illustrating a device 700 for optimizing an air mouse remote controller, according to an exemplary embodiment. In addition to the first obtaining module 11, the acquisition module 12, and the first processing module 13 (FIG. 4), the device 700 may further include: a second processing module 15 configured to obtain and store position points of a cursor along a motion trajectory on an operation interface of a terminal device and a time corresponding to each of the position points. The cursor corresponds to an air mouse remote controller.

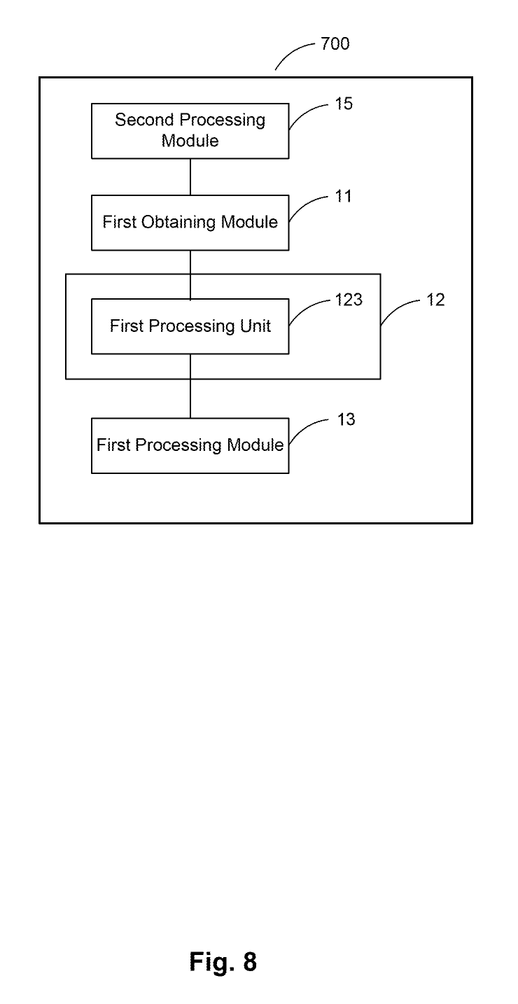

FIG. 8 is a block diagram illustrating the device 700 (FIG. 7), according to an exemplary embodiment. In FIG. 8, the acquisition module 12 may further include: a first processing unit 123 configured to obtain a position point of the cursor corresponding to a second time point along the motion trajectory, and determine a control corresponding to the position point on the operation interface as the first control.

In some embodiments of the present disclosure, erroneous displacement during a press operation by a user can be compensated by time adjustment. A terminal device may record and store coordinate information of the position points on the motion trajectories of the air mouse remote controller within a period of time and a time point of moving to each position point, calculate a second time point from the first time point and the preset length of time after receiving the operation instructions, search and acquire coordinates of the air mouse remote controller at the second time point from the stored information, acquire a control selected by the air mouse remote controller at this position according to the preset algorithm and a mapping relationship, and perform an operation corresponding to the control. Thus, the displacement during a press operation of the user can be compensated, the selection error due to the hand displacement during the key operation can be avoided, and the accuracy of the terminal device controlled by the air mouse remote controller can be improved effectively.

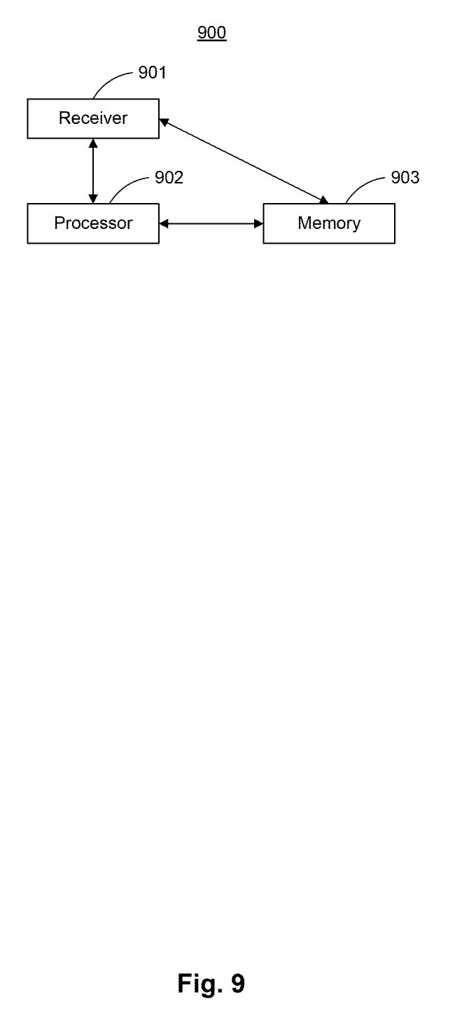

FIG. 9 is a block diagram illustrating a terminal device 900 for optimizing an air mouse remote controller, according to an exemplary embodiment. Referring to FIG. 9, the terminal device 900 may include: a receiver 901, a processor 902, and a memory 903.

The receiver 901 is configured to: obtain operation instructions sent by the air mouse remote controller at a first time point. The processor 902 is configured to: determine a first control selected by the air mouse remote controller on an operation interface of a terminal device at a second time point, the second time point being earlier than the first time point, and a time difference between the first time point and the second time point being a preset length of time; and perform an operation corresponding to the first control.

In some embodiments, the processor 902 may be a Central Processing Unit (CPU), a Digital Signal Processor (DSP), an Application Specific Integrated Circuit (ASIC), or the like. The memory 903 may be a read-only memory (ROM), a random access memory (RAM), a flash memory, a hard disk, or a solid state disk.

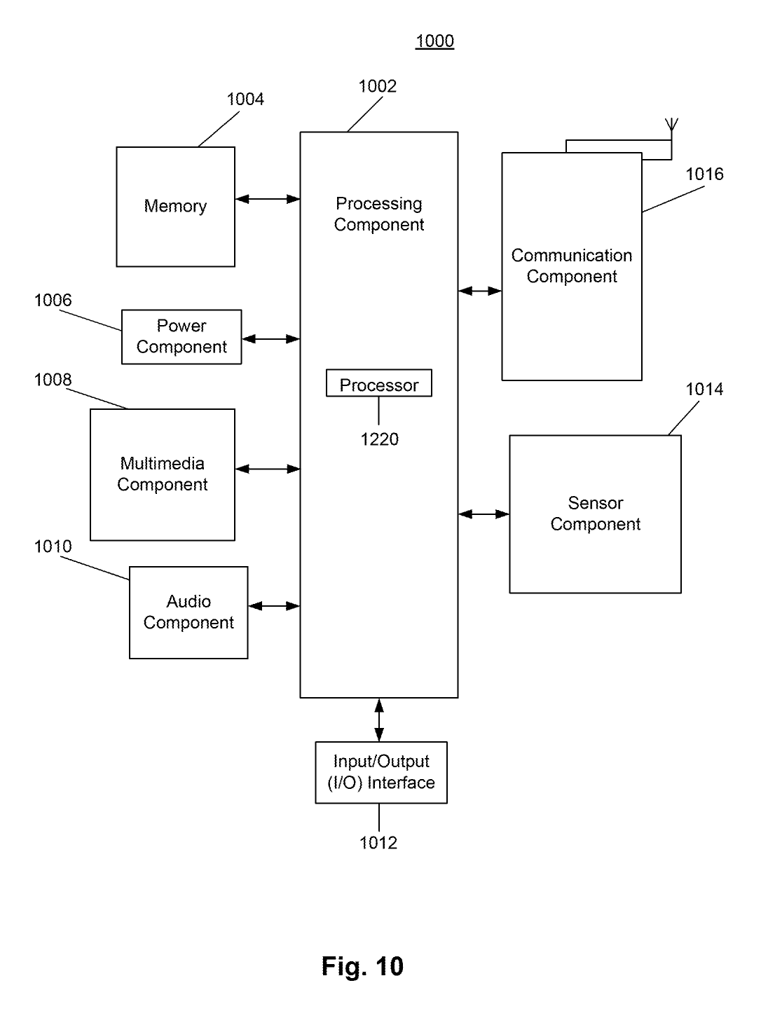

FIG. 10 is a block diagram illustrating a terminal device 1000 for optimizing an air mouse remote controller, according to an exemplary embodiment. The terminal device 1000 may be a device controlled by the air mouse remote controller, such as a smart television, a tablet computer, a computer, a digital broadcast terminal, a messaging device, a tablet device, a medical device, exercise equipment, a smart home device, and smart household appliance.

Referring to FIG. 10, the terminal device 1000 may include one or more of the following components: a processing component 1002, a memory 1004, a power component 1006, a multimedia component 1008, an audio component 1010, an input/output (I/O) interface 1012, a sensor component 1014, and a communication component 1016.

The processing component 1002 may control overall operations of the terminal device 1000, such as display, telephone calls, data communications, camera operations, and recording operations. The processing component 1002 may include one or more processors 1020 to execute instructions to perform all or part of the steps in the above-described methods. Moreover, the processing component 1002 may include one or more modules which facilitate the interaction between the processing component 1002 and other components. For instance, the processing component 1002 may include a multimedia module to facilitate the interaction between the multimedia component 1008 and the processing component 1002.

The memory 1004 is configured to store various types of data to support the operation of the terminal device 1000. Examples of such data include instructions for any applications or methods operated on the terminal device 1000, contact data, phonebook data, messages, pictures, video, etc. The memory 1004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1006 may provide power to various components of the terminal device 1000. The power component 1006 may include a power management system, one or more power sources, and any other components associated with the generation, management, and distribution of power in the terminal device 1000.

The multimedia component 1008 may include a screen providing an output interface between the terminal device 1000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action.

The audio component 1010 is configured to output and/or input audio signals. For example, the audio component 1010 may include a microphone (“MIC”) configured to receive an external audio signal when the terminal device 1000 is in an operation mode, such as a call mode, a recording mode, and a voice recognition mode. The received audio signal may be further stored in the memory 1004 or transmitted via the communication component 1016. In some embodiments, the audio component 1010 may further include a speaker to output audio signals.

The I/O interface 1012 may provide an interface between the processing component 1002 and peripheral interface modules, such as a keyboard, a click wheel, buttons, and the like. The buttons may include, but are not limited to, a home button, a volume button, a starting button, and a locking button.

The sensor component 1014 may include one or more sensors to provide status assessments of various aspects of the terminal device 1000. For instance, the sensor component 1014 may detect an open/closed status of the terminal device 1000, relative positioning of components, e.g., the display and the keypad, of the terminal device 1000, a change in position of the terminal device 1000, or a component of the terminal device 1000, a presence or absence of user contact with the terminal device 1000, an orientation or an acceleration/deceleration of the terminal device 1000, and a change in temperature of the terminal device 1000. The sensor component 1014 may include a proximity sensor configured to detect the presence of nearby objects without any physical contact. The sensor component 1014 may also include a light sensor, such as a CMOS or CCD image sensor, for use in imaging applications. In some embodiments, the sensor component 1014 may also include an accelerometer sensor, a gyroscope sensor, a magnetic sensor, a pressure sensor, or a temperature sensor.

The communication component 1016 is configured to facilitate communication, wired or wirelessly, between the terminal device 1000 and other devices. The terminal device 1000 can access a wireless network based on a communication standard, such as WiFi, 2G, 3G or a combination thereof. In one exemplary embodiment, the communication component 1016 may receive a broadcast signal or broadcast associated information from an external broadcast management system via a broadcast channel In one exemplary embodiment, the communication component 1016 may further include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 1000 may include one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods for optimizing an air mouse remote controller.

In exemplary embodiments, there is also provided a non-transitory computer-readable storage medium including instructions, such as included in the memory 1004, executable by the processor 1020 in the terminal device 1000, to perform the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for optimizing an air mouse remote controller, comprising:
obtaining operation instructions from an air mouse remote controller at a first time point;
determining a first control selected by the air mouse remote controller on an operation interface of a terminal device at a second time point, the second time point being earlier than the first time point, and a time difference between the first time point and the second time point being a preset length of time; and
performing an operation corresponding to the first control.

2. The method according to claim 1, before determining the first control selected by the air mouse remote controller on the operation interface of the terminal device at the second time point, further comprising:
obtaining and storing coordinates of the air mouse remote controller and a time point corresponding to each of the coordinates in real time.

3. The method according to claim 2, wherein determining the first control selected by the air mouse remote controller on the operation interface of the terminal device at the second time point comprises:
obtaining a first coordinate of the air mouse remote controller at the second time point; and
obtaining a first position point of a cursor corresponding to the first coordinate according to a preset algorithm, and determining a control corresponding to the first position point on the operation interface as the first control.

4. The method according to claim 1, before determining the first control selected by the air mouse remote controller on the operation interface of the terminal device at the second time point, further comprising:
obtaining and storing position points of a cursor along a motion trajectory on an operation interface of a terminal device, the cursor corresponding to the air mouse remote controller, and a time point corresponding to each of the position points in real time.

5. The method according to claim 4, wherein determining the first control selected by the air mouse remote controller on the operation interface of the terminal device at the second time point comprises:
obtaining a position point of the cursor corresponding to the second time point along the motion trajectory; and
determining a control corresponding to the obtained position point on the operation interface as the first control.

6. A terminal device, comprising:
a receiver configured to obtain operation instructions from an air mouse remote controller at a first time point; and
a processor configured to:
determine a first control selected by the air mouse remote controller on an operation interface of the terminal device at a second time point, the second time point being earlier than the first time point, and a time difference between the first time point and the second time point being a preset length of time, and
perform an operation corresponding to the first control.

7. The terminal device according to claim 6, wherein the processor is further configured to:
obtain and store coordinates of the air mouse remote controller and a time point corresponding to each of the coordinates in real time.

8. The terminal device according to claim 7, wherein the processor is further configured to:
obtain a first coordinate of the air mouse remote controller at the second time point; and
obtain a first position point of a cursor corresponding to the first coordinate according to a preset algorithm, and determining a control corresponding to the first position point on the operation interface as the first control.

9. The terminal device according to claim 6, wherein the processor is further configured to:
obtain and store position points of a cursor along a motion trajectory on an operation interface of a terminal device, the cursor corresponding to the air mouse remote controller, and a time point corresponding to each of the position points in real time.

10. The terminal device according to claim 9, wherein the processor is further configured to:
obtain position point of the cursor corresponding to the second time point along the motion trajectory; and
determine a control corresponding to the obtained position point on the operation interface as the first control.

11. A non-transitory computer-readable storage medium comprising instructions that, when executed by a processor in a device for optimizing an air mouse remote controller, cause the device to perform a method comprising:
obtaining operation instructions from the air mouse remote controller at a first time point;
determining a first control selected by the air mouse remote controller on an operation interface of the device at a second time point, the second time point being earlier than the first time point, and a time difference between the first time point and the second time point being a preset length of time; and
performing an operation corresponding to the first control.
